(19) United States
(12) Patent Application Publication
(10) Pub. No.: US 2026/0045267 A1
(43) Pub. Date: Feb. 12, 2026

(54) WIND AVOIDANCE AUDIO OPTIMIZATION FOR VOICE

(71) Applicant: GoPro, Inc., San Mateo, CA (US)

(72) Inventor: Erich Tisch, San Francisco, CA (US)

(21) Appl. No.: 18/795,504

(22) Filed: Aug. 6, 2024

(51) Int. Cl. G10L 21/0232; G10L 21/0216; G10L 25/21

(52) U.S. Cl. CPC G10L 21/0232; G10L 25/21; G10L 2021/02165

(57) ABSTRACT

An image capture device determines a coherence value between two or more microphones. The microphone signals produced by the two or more microphones each include a non-voice sub-band and a voice sub-band. The non-voice sub-band and the voice sub-band each comprise frequency bins. The coherence value is measured per bin for each of the microphone signals. The non-voice sub-band frequency bins from the first microphone signal and the second microphone signal that have the lowest energy value are selected for generating a composite signal. The voice sub-band frequency bins from a predetermined microphone signal are selected for generating the composite signal. Alternatively, the voice sub-band bins can be selected based on the average minimum energy across the voice band. The composite signal that includes the selected non-voice sub-band frequency bins and the voice sub-band frequency bins is output to a memory of the image capture device.

### TECHNICAL FIELD

This disclosure relates to audio processing. In particular, this disclosure relates to audio processing of voice audio in the presence of wind.

### BACKGROUND

Wind noise can be detected by microphones of a device, such as an image capture device. The wind noise that is detected by the microphones can obscure voice audio that is detected by the microphones. The interference caused by the detected wind noise can result in an unpleasant and unnatural recording of the voice audio. Methods for optimizing voice audio in the presence of wind noise are needed.

### SUMMARY

Disclosed herein are implementations of an image capture device and a method for optimizing voice audio in the presence of wind interference. In an aspect, an image capture device includes a first microphone, a second microphone, and a processor. The processor may be configured to obtain a first microphone signal from the first microphone. The processor may be configured to obtain a second microphone signal from the second microphone. The processor may be configured to determine coherence values between the first microphone signal and the second microphone signal across a frequency band. The frequency band may include a voice sub-band and non-voice sub-bands. The voice sub-band and the non-voice sub-bands may each include frequency bins. The processor may be configured to determine a coherence value for each frequency bin. The processor may be configured to determine that wind is present based on the determined coherence values for each frequency bin. The processor may be configured to select non-voice sub-band frequency bins from the first microphone signal and the second microphone signal based on a lowest energy value of each respective non-voice sub-band frequency bin. The processor may be configured to select voice sub-band frequency bins from a predetermined microphone signal. The processor may be configured to output a composite signal that comprises the selected non-voice sub-band frequency bins and the selected voice sub-band frequency bins.

In an aspect, an image capture device includes a first microphone, a second microphone, and a processor. The processor may be configured to obtain a first microphone signal from the first microphone. The processor may be configured to obtain a second microphone signal from the second microphone. The processor may be configured to determine coherence values between the first microphone signal and the second microphone signal across a frequency band. The frequency band may include a voice sub-band and non-voice sub-bands. The voice sub-band and the non-voice sub-bands may each include frequency bins. The processor may be configured to determine a coherence value for each frequency bin. The processor may be configured to determine that wind is present based on the determined coherence values for each frequency bin. The processor may be configured to select non-voice sub-band frequency bins from the first microphone signal and the second microphone signal based on a lowest energy value of each respective non-voice sub-band frequency bin. The processor may be configured to select voice sub-band frequency bins from the first microphone signal based on a threshold. The processor may be configured to output a composite signal that comprises the selected non-voice sub-band frequency bins and the selected voice sub-band frequency bins.

In an aspect, a method may include obtaining a first microphone signal from a first microphone. The method may include obtaining a second microphone signal from a second microphone. The method may include determining coherence values between the first microphone signal and the second microphone signal across a frequency band. The frequency band may include a voice sub-band and non-voice sub-bands. The voice sub-band and the non-voice sub-bands may each include frequency bins. The method may include determining a coherence value for each frequency bin. The method may include determining that wind is present based on the determined coherence values for each frequency bin. The method may include selecting non-voice sub-band frequency bins from the first microphone signal and the second microphone signal based on a lowest energy value of each respective non-voice sub-band frequency bin. The method may include selecting voice sub-band frequency bins from the first microphone signal based on a lowest coherence value. The processor may be configured to output a composite signal that comprises the selected non-voice sub-band frequency bins and the selected voice sub-band frequency bins.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1B are isometric views of an example of an image capture apparatus.

FIGS. 2A-2B are isometric views of another example of an image capture apparatus.

FIG. 3 is a top view of another example of an image capture apparatus.

FIGS. 4A-4B are isometric views of another example of an image capture apparatus.

FIG. 5 is a block diagram of electronic components of an image capture apparatus.

FIGS. 6A-6B are block diagrams of examples of composite microphone signals that are optimized for voice.

FIG. 7A is a flow diagram of an example of a method for generating a composite microphone signal that is optimized for voice using a predetermined microphone signal for the voice sub-band.

FIG. 7B is a flow diagram of an example of a method for generating a composite microphone signal that is optimized for voice using a threshold for selection of the voice sub-band frequency bins.

FIG. 7C is a flow diagram of an example of a method for generating a composite microphone signal that is optimized for voice using a lowest coherence value for selection of the voice sub-band frequency bins.

### DETAILED DESCRIPTION

Devices, such as image capture devices, have two or more microphones that can detect wind noise, for example, when recording video. The devices may be implemented using various microphone configurations. For example, the devices may have a three microphone configuration, a six microphone configuration, or a configuration having any number of microphones. The wind noise that is detected by the two or more microphones can interfere with voice audio that is also detected by the two or more microphones. The interference caused by the wind noise can be an unpleasant and unnatural artifact in the recorded audio portion of the video.

The implementations described herein include methods and devices that are configured to optimize the voice audio in the presence of wind noise to provide an improved user experience. The implementations described herein may use voice detection to enter a voice optimization mode or may enter the voice optimization mode via a device setting. The implementations described herein determine a coherence value between two or more microphones. The microphone signals produced by the two or more microphones each comprise a non-voice sub-band and a voice sub-band. The non-voice sub-band and the voice sub-band each comprise frequency bins. The coherence value is measured per bin for each of the microphone signals. The non-voice sub-band frequency bins from the first microphone signal and the second microphone signal that have the lowest energy value may be selected for generating a composite signal. The voice sub-band frequency bins from a predetermined microphone signal may be selected for generating the composite signal. The composite signal that includes the selected non-voice sub-band frequency bins and the voice sub-band frequency bins is output to a memory of the device.

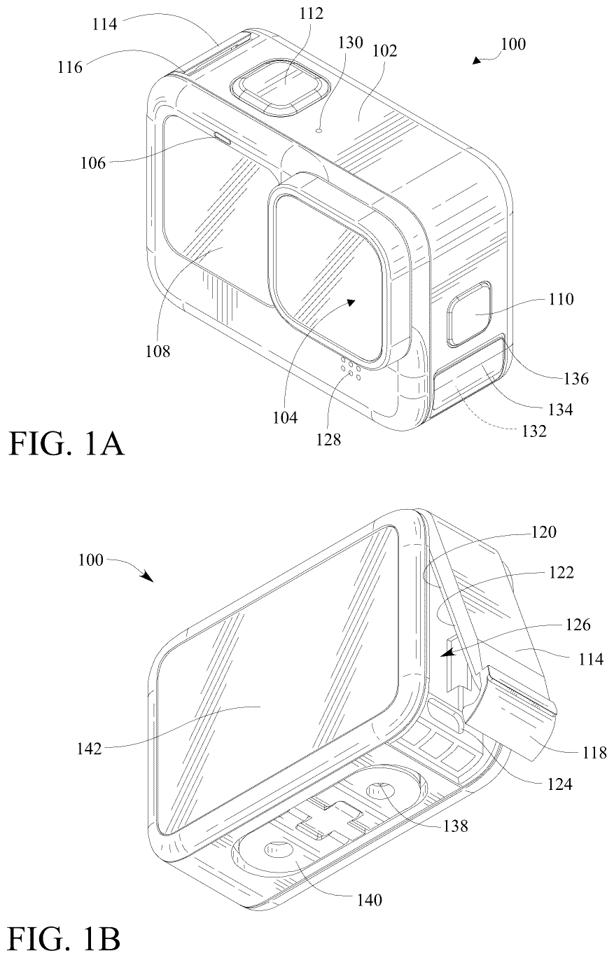

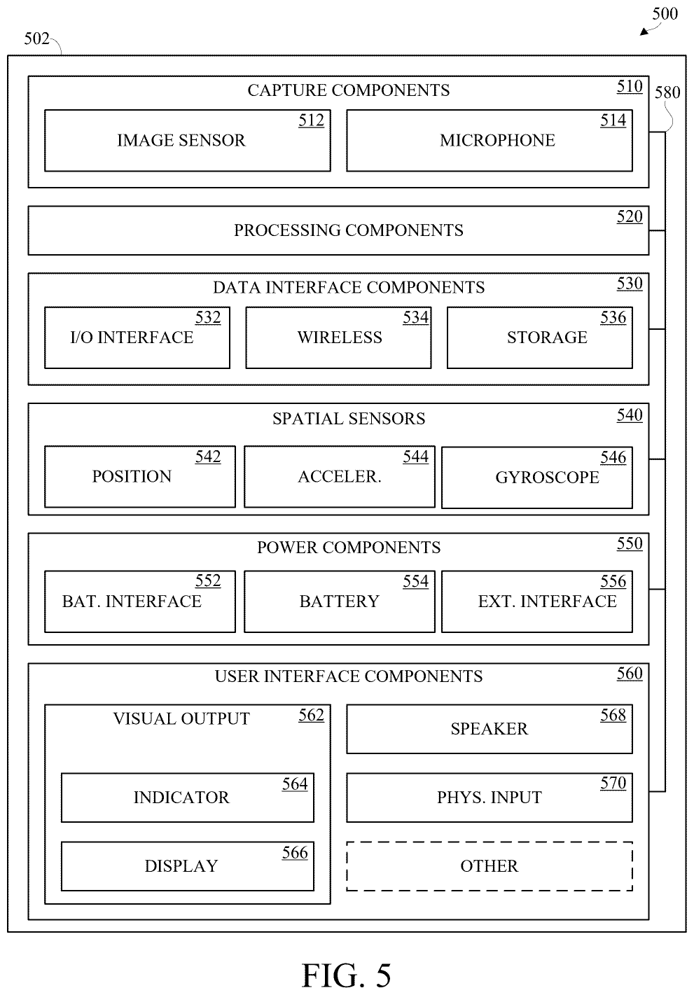

FIGS. 1A-1B are isometric views of an example of an image capture apparatus 100. The image capture apparatus 100 includes a body 102, an image capture device 104, an indicator 106, a display 108, a mode button 110, a shutter button 112, a door 114, a hinge mechanism 116, a latch mechanism 118, a seal 120, a battery interface 122, a data interface 124, a battery receptacle 126, microphones 128, 130, 132, a speaker 138, an interconnect mechanism 140, and a display 142. Although not expressly shown in FIGS. 1A-1B, the image capture apparatus 100 includes internal electronics, such as imaging electronics, power electronics, and the like, internal to the body 102 for capturing images and performing other functions of the image capture apparatus 100. An example showing internal electronics is shown in FIG. 5. The arrangement of the components of the image capture apparatus 100 shown in FIGS. 1A-1B is an example, other arrangements of elements may be used, except as is described herein or as is otherwise clear from context.

The body 102 of the image capture apparatus 100 may be made of a rigid material such as plastic, aluminum, steel, or fiberglass. Other materials may be used. The image capture device 104 is structured on a front surface of, and within, the body 102. The image capture device 104 includes a lens. The lens of the image capture device 104 receives light incident upon the lens of the image capture device 104 and directs the received light onto an image sensor of the image capture device 104 internal to the body 102. The image capture apparatus 100 may capture one or more images, such as a sequence of images, such as video. The image capture apparatus 100 may store the captured images and video for subsequent display, playback, or transfer to an external device. Although one image capture device 104 is shown in FIG. 1A, the image capture apparatus 100 may include multiple image capture devices, which may be structured on respective surfaces of the body 102.

As shown in FIG. 1A, the image capture apparatus 100 includes the indicator 106 structured on the front surface of the body 102. The indicator 106 may output, or emit, visible light, such as to indicate a status of the image capture apparatus 100. For example, the indicator 106 may be a light-emitting diode (LED). Although one indicator 106 is shown in FIG. 1A, the image capture apparatus 100 may include multiple indictors structured on respective surfaces of the body 102.

As shown in FIG. 1A, the image capture apparatus 100 includes the display 108 structured on the front surface of the body 102. The display 108 outputs, such as presents or displays, such as by emitting visible light, information, such as to show image information such as image previews, live video capture, or status information such as battery life, camera mode, elapsed time, and the like. In some implementations, the display 108 may be an interactive display, which may receive, detect, or capture input, such as user input representing user interaction with the image capture apparatus 100. In some implementations, the display 108 may be omitted or combined with another component of the image capture apparatus 100.

As shown in FIG. 1A, the image capture apparatus 100 includes the mode button 110 structured on a side surface of the body 102. Although described as a button, the mode button 110 may be another type of input device, such as a switch, a toggle, a slider, or a dial. Although one mode button 110 is shown in FIG. 1A, the image capture apparatus 100 may include multiple mode, or configuration, buttons structured on respective surfaces of the body 102. In some implementations, the mode button 110 may be omitted or combined with another component of the image capture apparatus 100. For example, the display 108 may be an interactive, such as touchscreen, display, and the mode button 110 may be physically omitted and functionally combined with the display 108.

As shown in FIG. 1A, the image capture apparatus 100 includes the shutter button 112 structured on a top surface of the body 102. The shutter button 112 may be another type of input device, such as a switch, a toggle, a slider, or a dial. The image capture apparatus 100 may include multiple shutter buttons structured on respective surfaces of the body 102. In some implementations, the shutter button 112 may be omitted or combined with another component of the image capture apparatus 100.

The mode button 110, the shutter button 112, or both, obtain input data, such as user input data in accordance with user interaction with the image capture apparatus 100. For example, the mode button 110, the shutter button 112, or both, may be used to turn the image capture apparatus 100 on and off, scroll through modes and settings, and select modes and change settings.

As shown in FIG. 1B, the image capture apparatus 100 includes the door 114 coupled to the body 102, such as using the hinge mechanism 116 (FIG. 1A). The door 114 may be secured to the body 102 using the latch mechanism 118 that releasably engages the body 102 at a position generally opposite the hinge mechanism 116. The door 114 includes the seal 120 and the battery interface 122. Although one door 114 is shown in FIG. 1A, the image capture apparatus 100 may include multiple doors respectively forming respective surfaces of the body 102, or portions thereof. The door 114 may be removable from the body 102 by releasing the latch mechanism 118 from the body 102 and decoupling the hinge mechanism 116 from the body 102.

In FIG. 1B, the door 114 is shown in a partially open position such that the data interface 124 is accessible for communicating with external devices and the battery receptacle 126 is accessible for placement or replacement of a battery. In FIG. 1A, the door 114 is shown in a closed position. In implementations in which the door 114 is in the closed position, the seal 120 engages a flange (not shown) to provide an environmental seal and the battery interface 122 engages the battery (not shown) to secure the battery in the battery receptacle 126.

As shown in FIG. 1B, the image capture apparatus 100 includes the battery receptacle 126 structured to form a portion of an interior surface of the body 102. The battery receptacle 126 includes operative connections for power transfer between the battery and the image capture apparatus 100. In some implementations, the battery receptacle 126 may be omitted. The image capture apparatus 100 may include multiple battery receptacles.

As shown in FIG. 1A, the image capture apparatus 100 includes a first microphone 128 structured on a front surface of the body 102, a second microphone 130 structured on a top surface of the body 102, and a third microphone 132 structured on a side surface of the body 102. The third microphone 132, which may be referred to as a drain microphone and is indicated as hidden in dotted line, is located behind a drain cover 134, surrounded by a drain channel 136, and can drain liquid from audio components of the image capture apparatus 100. The image capture apparatus 100 may include other microphones on other surfaces of the body 102. The microphones 128, 130, 132 receive and record audio, such as in conjunction with capturing video or separate from capturing video. In some implementations, one or more of the microphones 128, 130, 132 may be omitted or combined with other components of the image capture apparatus 100.

As shown in FIG. 1B, the image capture apparatus 100 includes the speaker 138 structured on a bottom surface of the body 102. The speaker 138 outputs or presents audio, such as by playing back recorded audio or emitting sounds associated with notifications. The image capture apparatus 100 may include multiple speakers structured on respective surfaces of the body 102.

As shown in FIG. 1B, the image capture apparatus 100 includes the interconnect mechanism 140 structured on a bottom surface of the body 102. The interconnect mechanism 140 removably connects the image capture apparatus 100 to an external structure, such as a handle grip, another mount, or a securing device. The interconnect mechanism 140 includes folding protrusions configured to move between a nested or collapsed position as shown in FIG. 1B and an extended or open position. The folding protrusions of the interconnect mechanism 140 in the extended or open position may be coupled to reciprocal protrusions of other devices such as handle grips, mounts, clips, or like devices. The image capture apparatus 100 may include multiple interconnect mechanisms structured on, or forming a portion of, respective surfaces of the body 102. In some implementations, the interconnect mechanism 140 may be omitted.

As shown in FIG. 1B, the image capture apparatus 100 includes the display 142 structured on, and forming a portion of, a rear surface of the body 102. The display 142 outputs, such as presents or displays, such as by emitting visible light, data, such as to show image information such as image previews, live video capture, or status information such as battery life, camera mode, elapsed time, and the like. In some implementations, the display 142 may be an interactive display, which may receive, detect, or capture input, such as user input representing user interaction with the image capture apparatus 100. The image capture apparatus 100 may include multiple displays structured on respective surfaces of the body 102, such as the displays 108, 142 shown in FIGS. 1A-1B. In some implementations, the display 142 may be omitted or combined with another component of the image capture apparatus 100.

The image capture apparatus 100 may include features or components other than those described herein, such as other buttons or interface features. In some implementations, interchangeable lenses, cold shoes, and hot shoes, or a combination thereof, may be coupled to or combined with the image capture apparatus 100. For example, the image capture apparatus 100 may communicate with an external device, such as an external user interface device, via a wired or wireless computing communication link, such as via the data interface 124. The computing communication link may be a direct computing communication link or an indirect computing communication link, such as a link including another device or a network, such as the Internet. The image capture apparatus 100 may transmit images to the external device via the computing communication link.

The external device may store, process, display, or combination thereof, the images. The external user interface device may be a computing device, such as a smartphone, a tablet computer, a smart watch, a portable computer, personal computing device, or another device or combination of devices configured to receive user input, communicate information with the image capture apparatus 100 via the computing communication link, or receive user input and communicate information with the image capture apparatus 100 via the computing communication link. The external user interface device may implement or execute one or more applications to manage or control the image capture apparatus 100. For example, the external user interface device may include an application for controlling camera configuration, video acquisition, video display, or any other configurable or controllable aspect of the image capture apparatus 100. In some implementations, the external user interface device may generate and share, such as via a cloud-based or social media service, one or more images or video clips. In some implementations, the external user interface device may display unprocessed or minimally processed images or video captured by the image capture apparatus 100 contemporaneously with capturing the images or video by the image capture apparatus 100, such as for shot framing or live preview.

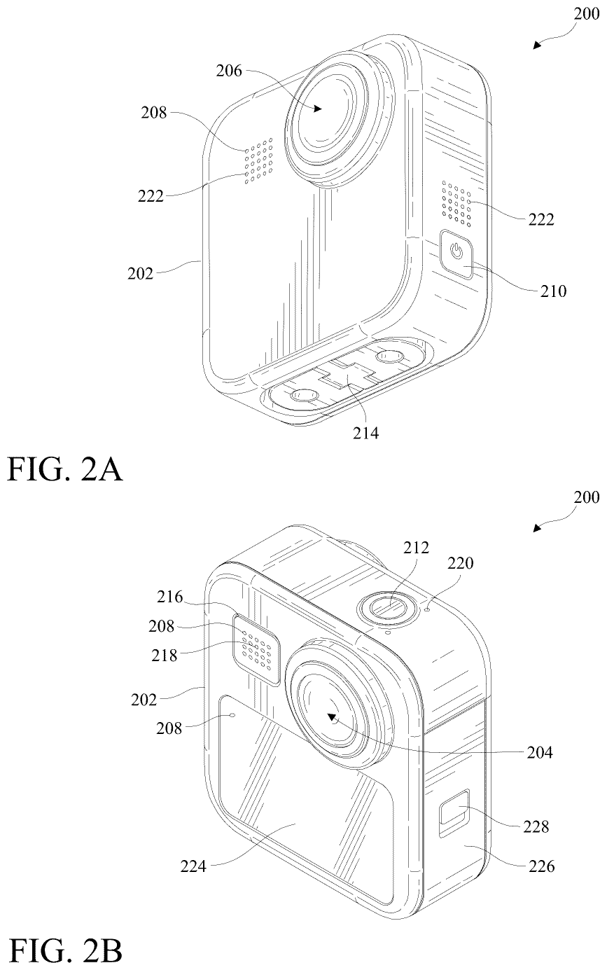

FIGS. 2A-2B illustrate another example of an image capture apparatus 200. The image capture apparatus 200 is similar to the image capture apparatus 100 shown in FIGS. 1A-1B. The image capture apparatus 200 includes a body 202, a first image capture device 204, a second image capture device 206, indicators 208, a mode button 210, a shutter button 212, an interconnect mechanism 214, a drainage channel 216, audio components 218, 220, 222, a display 224, and a door 226 including a release mechanism 228. The arrangement of the components of the image capture apparatus 200 shown in FIGS. 2A-2B is an example, other arrangements of elements may be used.

The body 202 of the image capture apparatus 200 may be similar to the body 102 shown in FIGS. 1A-1B. The first image capture device 204 is structured on a front surface of the body 202. The first image capture device 204 includes a first lens. The first image capture device 204 may be similar to the image capture device 104 shown in FIG. 1A. As shown in FIG. 2A, the image capture apparatus 200 includes the second image capture device 206 structured on a rear surface of the body 202. The second image capture device 206 includes a second lens. The second image capture device 206 may be similar to the image capture device 104 shown in FIG. 1A. The image capture devices 204, 206 are disposed on opposing surfaces of the body 202, for example, in a back-to-back configuration, Janus configuration, or offset Janus configuration. The image capture apparatus 200 may include other image capture devices structured on respective surfaces of the body 202.

As shown in FIG. 2B, the image capture apparatus 200 includes the indicators 208 associated with the audio component 218 and the display 224 on the front surface of the body 202. The indicators 208 may be similar to the indicator 106 shown in FIG. 1A. For example, one of the indicators 208 may indicate a status of the first image capture device 204 and another one of the indicators 208 may indicate a status of the second image capture device 206. Although two indicators 208 are shown in FIGS. 2A-2B, the image capture apparatus 200 may include other indictors structured on respective surfaces of the body 202.

As shown in FIGS. 2A-2B, the image capture apparatus 200 includes input mechanisms including the mode button 210, structured on a side surface of the body 202, and the shutter button 212, structured on a top surface of the body 202. The mode button 210 may be similar to the mode button 110 shown in FIG. 1B. The shutter button 212 may be similar to the shutter button 112 shown in FIG. 1A.

The image capture apparatus 200 includes internal electronics (not expressly shown), such as imaging electronics, power electronics, and the like, internal to the body 202 for capturing images and performing other functions of the image capture apparatus 200. An example showing internal electronics is shown in FIG. 5.

As shown in FIGS. 2A-2B, the image capture apparatus 200 includes the interconnect mechanism 214 structured on a bottom surface of the body 202. The interconnect mechanism 214 may be similar to the interconnect mechanism 140 shown in FIG. 1B.

As shown in FIG. 2B, the image capture apparatus 200 includes the drainage channel 216 for draining liquid from audio components of the image capture apparatus 200.

As shown in FIGS. 2A-2B, the image capture apparatus 200 includes the audio components 218, 220, 222, respectively structured on respective surfaces of the body 202. The audio components 218, 220, 222 may be similar to the microphones 128, 130, 132 and the speaker 138 shown in FIGS. 1A-1B. One or more of the audio components 218, 220, 222 may be, or may include, audio sensors, such as microphones, to receive and record audio signals, such as voice commands or other audio, in conjunction with capturing images or video. One or more of the audio components 218, 220, 222 may be, or may include, an audio presentation component that may present, or play, audio, such as to provide notifications or alerts.

As shown in FIGS. 2A-2B, a first audio component 218 is located on a front surface of the body 202, a second audio component 220 is located on a top surface of the body 202, and a third audio component 222 is located on a back surface of the body 202. Other numbers and configurations for the audio components 218, 220, 222 may be used. For example, the audio component 218 may be a drain microphone surrounded by the drainage channel 216 and adjacent to one of the indicators 208 as shown in FIG. 2B.

As shown in FIG. 2B, the image capture apparatus 200 includes the display 224 structured on a front surface of the body 202. The display 224 may be similar to the displays 108, 142 shown in FIGS. 1A-1B. The display 224 may include an I/O interface. The display 224 may include one or more of the indicators 208. The display 224 may receive touch inputs. The display 224 may display image information during video capture. The display 224 may provide status information to a user, such as status information indicating battery power level, memory card capacity, time elapsed for a recorded video, etc. The image capture apparatus 200 may include multiple displays structured on respective surfaces of the body 202. In some implementations, the display 224 may be omitted or combined with another component of the image capture apparatus 200.

As shown in FIG. 2B, the image capture apparatus 200 includes the door 226 structured on, or forming a portion of, the side surface of the body 202. The door 226 may be similar to the door 114 shown in FIG. 1A. For example, the door 226 shown in FIG. 2A includes a release mechanism 228. The release mechanism 228 may include a latch, a button, or other mechanism configured to receive a user input that allows the door 226 to change position. The release mechanism 228 may be used to open the door 226 for a user to access a battery, a battery receptacle, an I/O interface, a memory card interface, etc.

In some embodiments, the image capture apparatus 200 may include features or components other than those described herein, some features or components described herein may be omitted, or some features or components described herein may be combined. For example, the image capture apparatus 200 may include additional interfaces or different interface features, interchangeable lenses, cold shoes, or hot shoes.

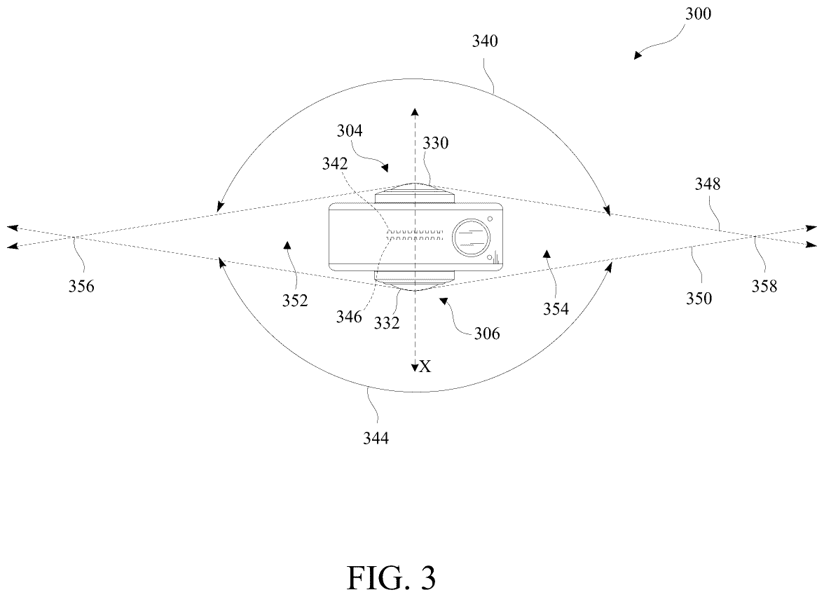

FIG. 3 is a top view of an image capture apparatus 300. The image capture apparatus 300 is similar to the image capture apparatus 200 of FIGS. 2A-2B and is configured to capture spherical images.

As shown in FIG. 3, a first image capture device 304 includes a first lens 330 and a second image capture device 306 includes a second lens 332. For example, the first image capture device 304 may capture a first image, such as a first hemispheric, or hyper-hemispherical, image, the second image capture device 306 may capture a second image, such as a second hemispheric, or hyper-hemispherical, image, and the image capture apparatus 300 may generate a spherical image incorporating or combining the first image and the second image, which may be captured concurrently, or substantially concurrently.

The first image capture device 304 defines a first field-of-view 340 wherein the first lens 330 of the first image capture device 304 receives light. The first lens 330 directs the received light corresponding to the first field-of-view 340 onto a first image sensor 342 of the first image capture device 304. For example, the first image capture device 304 may include a first lens barrel (not expressly shown), extending from the first lens 330 to the first image sensor 342.

The second image capture device 306 defines a second field-of-view 344 wherein the second lens 332 receives light. The second lens 332 directs the received light corresponding to the second field-of-view 344 onto a second image sensor 346 of the second image capture device 306. For example, the second image capture device 306 may include a second lens barrel (not expressly shown), extending from the second lens 332 to the second image sensor 346.

A boundary 348 of the first field-of-view 340 is shown using broken directional lines. A boundary 350 of the second field-of-view 344 is shown using broken directional lines. As shown, the image capture devices 304, 306 are arranged in a back-to-back (Janus) configuration such that the lenses 330, 332 face in opposite directions, and such that the image capture apparatus 300 may capture spherical images. The first image sensor 342 captures a first hyper-hemispherical image plane from light entering the first lens 330. The second image sensor 346 captures a second hyper-hemispherical image plane from light entering the second lens 332.

As shown in FIG. 3, the fields-of-view 340, 344 partially overlap such that the combination of the fields-of-view 340, 344 forms a spherical field-of-view, except that one or more uncaptured areas 352, 354 may be outside of the fields-of-view 340, 344 of the lenses 330, 332. Light emanating from or passing through the uncaptured areas 352, 354, which may be proximal to the image capture apparatus 300, may be obscured from the lenses 330, 332 and the corresponding image sensors 342, 346, such that content corresponding to the uncaptured areas 352, 354 may be omitted from images captured by the image capture apparatus 300. In some implementations, the image capture devices 304, 306, or the lenses 330, 332 thereof, may be configured to minimize the uncaptured areas 352, 354.

Examples of points of transition, or overlap points, from the uncaptured areas 352, 354 to the overlapping portions of the fields-of-view 340, 344 are shown at 356, 358.

Images contemporaneously captured by the respective image sensors 342, 346 may be combined to form a combined image, such as a spherical image. Generating a combined image may include correlating the overlapping regions captured by the respective image sensors 342, 346, aligning the captured fields-of-view 340, 344, and stitching the images together to form a cohesive combined image. Stitching the images together may include correlating the overlap points 356, 358 with respective locations in corresponding images captured by the image sensors 342, 346. Although a planar view of the fields-of-view 340, 344 is shown in FIG. 3, the fields-of-view 340, 344 are hyper-hemispherical.

A change in the alignment, such as position, tilt, or a combination thereof, of the image capture devices 304, 306, such as of the lenses 330, 332, the image sensors 342, 346, or both, may change the relative positions of the respective fields-of-view 340, 344, may change the locations of the overlap points 356, 358, such as with respect to images captured by the image sensors 342, 346, and may change the uncaptured areas 352, 354, which may include changing the uncaptured areas 352, 354 unequally.

Incomplete or inaccurate information indicating the alignment of the image capture devices 304, 306, such as the locations of the overlap points 356, 358, may decrease the accuracy, efficiency, or both of generating a combined image. In some implementations, the image capture apparatus 300 may maintain information indicating the location and orientation of the image capture devices 304, 306, such as of the lenses 330, 332, the image sensors 342, 346, or both, such that the fields-of-view 340, 344, the overlap points 356, 358, or both may be accurately determined, which may improve the accuracy, efficiency, or both of generating a combined image.

The lenses 330, 332 may be aligned along an axis X as shown, laterally offset from each other (not shown), off-center from a central axis of the image capture apparatus 300 (not shown), or laterally offset and off-center from the central axis (not shown). Whether through use of offset or through use of compact image capture devices 304, 306, a reduction in distance between the lenses 330, 332 along the axis X may improve the overlap in the fields-of-view 340, 344, such as by reducing the uncaptured areas 352, 354.

Images or frames captured by the image capture devices 304, 306 may be combined, merged, or stitched together to produce a combined image, such as a spherical or panoramic image, which may be an equirectangular planar image. In some implementations, generating a combined image may include use of techniques such as noise reduction, tone mapping, white balancing, or other image correction. In some implementations, pixels along a stitch boundary, which may correspond with the overlap points 356, 358, may be matched accurately to minimize boundary discontinuities.

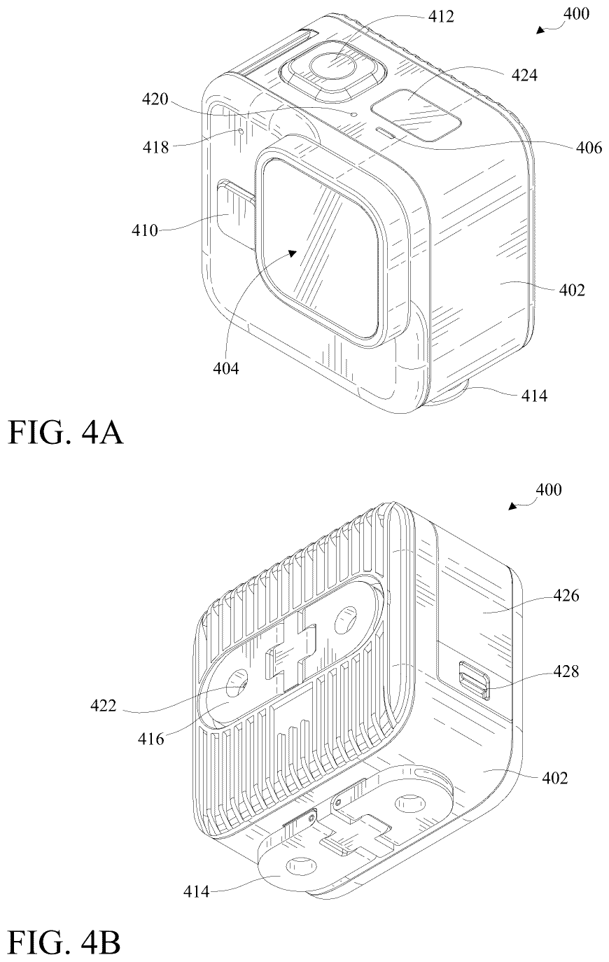

FIGS. 4A-4B illustrate another example of an image capture apparatus 400. The image capture apparatus 400 is similar to the image capture apparatus 100 shown in FIGS. 1A-1B and to the image capture apparatus 200 shown in FIGS. 2A-2B. The image capture apparatus 400 includes a body 402, an image capture device 404, an indicator 406, a mode button 410, a shutter button 412, interconnect mechanisms 414, 416, audio components 418, 420, 422, a display 424, and a door 426 including a release mechanism 428. The arrangement of the components of the image capture apparatus 400 shown in FIGS. 4A-4B is an example, other arrangements of elements may be used.

The body 402 of the image capture apparatus 400 may be similar to the body 102 shown in FIGS. 1A-1B. The image capture device 404 is structured on a front surface of the body 402. The image capture device 404 includes a lens and may be similar to the image capture device 104 shown in FIG. 1A.

As shown in FIG. 4A, the image capture apparatus 400 includes the indicator 406 on a top surface of the body 402. The indicator 406 may be similar to the indicator 106 shown in FIG. 1A. The indicator 406 may indicate a status of the image capture device 204. Although one indicator 406 is shown in FIGS. 4A, the image capture apparatus 400 may include other indictors structured on respective surfaces of the body 402.

As shown in FIGS. 4A, the image capture apparatus 400 includes input mechanisms including the mode button 410, structured on a front surface of the body 402, and the shutter button 412, structured on a top surface of the body 402. The mode button 410 may be similar to the mode button 110 shown in FIG. 1B. The shutter button 412 may be similar to the shutter button 112 shown in FIG. 1A.

The image capture apparatus 400 includes internal electronics (not expressly shown), such as imaging electronics, power electronics, and the like, internal to the body 402 for capturing images and performing other functions of the image capture apparatus 400. An example showing internal electronics is shown in FIG. 5.

As shown in FIGS. 4A-4B, the image capture apparatus 400 includes the interconnect mechanisms 414, 416, with a first interconnect mechanism 414 structured on a bottom surface of the body 402 and a second interconnect mechanism 416 disposed within a rear surface of the body 402. The interconnect mechanisms 414, 416 may be similar to the interconnect mechanism 140 shown in FIG. 1B and the interconnect mechanism 214 shown in FIG. 2A.

As shown in FIGS. 4A-4B, the image capture apparatus 400 includes the audio components 418, 420, 422 respectively structured on respective surfaces of the body 402. The audio components 418, 420, 422 may be similar to the microphones 128, 130, 132 and the speaker 138 shown in FIGS. 1A-1B. One or more of the audio components 418, 420, 422 may be, or may include, audio sensors, such as microphones, to receive and record audio signals, such as voice commands or other audio, in conjunction with capturing images or video. One or more of the audio components 418, 420, 422 may be, or may include, an audio presentation component that may present, or play, audio, such as to provide notifications or alerts.

As shown in FIGS. 4A-4B, a first audio component 418 is located on a front surface of the body 402, a second audio component 420 is located on a top surface of the body 402, and a third audio component 422 is located on a rear surface of the body 402. Other numbers and configurations for the audio components 418, 420, 422 may be used.

As shown in FIG. 4A, the image capture apparatus 400 includes the display 424 structured on a front surface of the body 402. The display 424 may be similar to the displays 108, 142 shown in FIGS. 1A-1B. The display 424 may include an I/O interface. The display 424 may receive touch inputs. The display 424 may display image information during video capture. The display 424 may provide status information to a user, such as status information indicating battery power level, memory card capacity, time elapsed for a recorded video, etc. The image capture apparatus 400 may include multiple displays structured on respective surfaces of the body 402. In some implementations, the display 424 may be omitted or combined with another component of the image capture apparatus 200.

As shown in FIG. 4B, the image capture apparatus 400 includes the door 426 structured on, or forming a portion of, the side surface of the body 402. The door 426 may be similar to the door 226 shown in FIG. 2B. The door 426 shown in FIG. 4B includes the release mechanism 428. The release mechanism 428 may include a latch, a button, or other mechanism configured to receive a user input that allows the door 426 to change position. The release mechanism 428 may be used to open the door 426 for a user to access a battery, a battery receptacle, an I/O interface, a memory card interface, etc.

In some embodiments, the image capture apparatus 400 may include features or components other than those described herein, some features or components described herein may be omitted, or some features or components described herein may be combined. For example, the image capture apparatus 400 may include additional interfaces or different interface features, interchangeable lenses, cold shoes, or hot shoes.

FIG. 5 is a block diagram of electronic components in an image capture apparatus 500. The image capture apparatus 500 may be a single-lens image capture device, a multi-lens image capture device, or variations thereof, including an image capture apparatus with multiple capabilities such as the use of interchangeable integrated sensor lens assemblies. Components, such as electronic components, of the image capture apparatus 100 shown in FIGS. 1A-1B, the image capture apparatus 200 shown in FIGS. 2A-2B, the image capture apparatus 300 shown in FIG. 3, or the image capture apparatus 400 shown in FIGS. 4A-4B, may be implemented as shown in FIG. 5.

The image capture apparatus 500 includes a body 502. The body 502 may be similar to the body 102 shown in FIGS. 1A-1B, the body 202 shown in FIGS. 2A-2B, or the body 402 shown in FIGS. 4A-4B. The body 502 includes electronic components such as capture components 510, processing components 520, data interface components 530, spatial sensors 540, power components 550, user interface components 560, and a bus 580.

The capture components 510 include an image sensor 512 for capturing images. Although one image sensor 512 is shown in FIG. 5, the capture components 510 may include multiple image sensors. The image sensor 512 may be similar to the image sensors 342, 346 shown in FIG. 3. The image sensor 512 may be, for example, a charge-coupled device (CCD) sensor, an active pixel sensor (APS), a complementary metal-oxide-semiconductor (CMOS) sensor, or an N-type metal-oxide-semiconductor (NMOS) sensor. The image sensor 512 detects light, such as within a defined spectrum, such as the visible light spectrum or the infrared spectrum, incident through a corresponding lens such as the first lens 330 with respect to the first image sensor 342 or the second lens 332 with respect to the second image sensor 346 as shown in FIG. 3. The image sensor 512 captures detected light as image data and conveys the captured image data as electrical signals (image signals or image data) to the other components of the image capture apparatus 500, such as to the processing components 520, such as via the bus 580.

The capture components 510 include a microphone 514 for capturing audio. Although one microphone 514 is shown in FIG. 5, the capture components 510 may include multiple microphones. The microphone 514 detects and captures, or records, sound, such as sound waves incident upon the microphone 514. The microphone 514 may detect, capture, or record sound in conjunction with capturing images by the image sensor 512. The microphone 514 may detect sound to receive audible commands to control the image capture apparatus 500. The microphone 514 may be similar to the microphones 128, 130, 132 shown in FIGS. 1A-1B, the audio components 218, 220, 222 shown in FIGS. 2A-2B, or the audio components 418, 420, 422 shown in FIGS. 4A-4B.

The processing components 520 perform image signal processing, such as filtering, tone mapping, or stitching, to generate, or obtain, processed images, or processed image data, based on image data obtained from the image sensor 512. The processing components 520 may include one or more processors having single or multiple processing cores. In some implementations, the processing components 520 may include, or may be, an application specific integrated circuit (ASIC) or a digital signal processor (DSP). For example, the processing components 520 may include a custom image signal processor. The processing components 520 conveys data, such as processed image data, with other components of the image capture apparatus 500 via the bus 580. In some implementations, the processing components 520 may include an encoder, such as an image or video encoder that may encode, decode, or both, the image data, such as for compression coding, transcoding, or a combination thereof.

Although not shown expressly in FIG. 5, the processing components 520 may include memory, such as a random-access memory (RAM) device, which may be non-transitory computer-readable memory. The memory of the processing components 520 may include executable instructions and data that can be accessed by the processing components 520.

The data interface components 530 communicates with other, such as external, electronic devices, such as a remote control, a smartphone, a tablet computer, a laptop computer, a desktop computer, or an external computer storage device. For example, the data interface components 530 may receive commands to operate the image capture apparatus 500. In another example, the data interface components 530 may transmit image data to transfer the image data to other electronic devices. The data interface components 530 may be configured for wired communication, wireless communication, or both. As shown, the data interface components 530 include an I/O interface 532, a wireless data interface 534, and a storage interface 536. In some implementations, one or more of the I/O interface 532, the wireless data interface 534, or the storage interface 536 may be omitted or combined.

The I/O interface 532 may send, receive, or both, wired electronic communications signals. For example, the I/O interface 532 may be a universal serial bus (USB) interface, such as USB type-C interface, a high-definition multimedia interface (HDMI), a FireWire interface, a digital video interface link, a display port interface link, a Video Electronics Standards Associated (VESA) digital display interface link, an Ethernet link, or a Thunderbolt link. Although one I/O interface 532 is shown in FIG. 5, the data interface components 530 include multiple I/O interfaces. The I/O interface 532 may be similar to the data interface 124 shown in FIG. 1B.

The wireless data interface 534 may send, receive, or both, wireless electronic communications signals. The wireless data interface 534 may be a Bluetooth interface, a ZigBee interface, a Wi-Fi interface, an infrared link, a cellular link, a near field communications (NFC) link, or an Advanced Network Technology interoperability (ANT+) link. Although one wireless data interface 534 is shown in FIG. 5, the data interface components 530 include multiple wireless data interfaces. The wireless data interface 534 may be similar to the data interface 124 shown in FIG. 1B.

The storage interface 536 may include a memory card connector, such as a memory card receptacle, configured to receive and operatively couple to a removable storage device, such as a memory card, and to transfer, such as read, write, or both, data between the image capture apparatus 500 and the memory card, such as for storing images, recorded audio, or both captured by the image capture apparatus 500 on the memory card. Although one storage interface 536 is shown in FIG. 5, the data interface components 530 include multiple storage interfaces. The storage interface 536 may be similar to the data interface 124 shown in FIG. 1B.

The spatial, or spatiotemporal, sensors 540 detect the spatial position, movement, or both, of the image capture apparatus 500. As shown in FIG. 5, the spatial sensors 540 include a position sensor 542, an accelerometer 544, and a gyroscope 546. The position sensor 542, which may be a global positioning system (GPS) sensor, may determine a geospatial position of the image capture apparatus 500, which may include obtaining, such as by receiving, temporal data, such as via a GPS signal. The accelerometer 544, which may be a three-axis accelerometer, may measure linear motion, linear acceleration, or both of the image capture apparatus 500. The gyroscope 546, which may be a three-axis gyroscope, may measure rotational motion, such as a rate of rotation, of the image capture apparatus 500. In some implementations, the spatial sensors 540 may include other types of spatial sensors. In some implementations, one or more of the position sensor 542, the accelerometer 544, and the gyroscope 546 may be omitted or combined.

The power components 550 distribute electrical power to the components of the image capture apparatus 500 for operating the image capture apparatus 500. As shown in FIG. 5, the power components 550 include a battery interface 552, a battery 554, and an external power interface 556 (ext. interface). The battery interface 552 (bat. interface) operatively couples to the battery 554, such as via conductive contacts to transfer power from the battery 554 to the other electronic components of the image capture apparatus 500. The battery interface 552 may be similar to the battery receptacle 126 shown in FIG. 1B. The external power interface 556 obtains or receives power from an external source, such as a wall plug or external battery, and distributes the power to the components of the image capture apparatus 500, which may include distributing power to the battery 554 via the battery interface 552 to charge the battery 554. Although one battery interface 552, one battery 554, and one external power interface 556 are shown in FIG. 5, any number of battery interfaces, batteries, and external power interfaces may be used. In some implementations, one or more of the battery interface 552, the battery 554, and the external power interface 556 may be omitted or combined. For example, in some implementations, the external interface 556 and the I/O interface 532 may be combined.

The user interface components 560 receive input, such as user input, from a user of the image capture apparatus 500, output, such as display or present, information to a user, or both receive input and output information, such as in accordance with user interaction with the image capture apparatus 500.

As shown in FIG. 5, the user interface components 560 include visual output components 562 to visually communicate information, such as to present captured images. As shown, the visual output components 562 include an indicator 564 and a display 566. The indicator 564 may be similar to the indicator 106 shown in FIG. 1A, the indicators 208 shown in FIGS. 2A-2B, or the indicator 406 shown in FIG. 4A. The display 566 may be similar to the display 108 shown in FIG. 1A, the display 142 shown in FIG. 1B, the display 224 shown in FIG. 2B, or the display 424 shown in FIG. 4A. Although the visual output components 562 are shown in FIG. 5 as including one indicator 564, the visual output components 562 may include multiple indicators. Although the visual output components 562 are shown in FIG. 5 as including one display 566, the visual output components 562 may include multiple displays. In some implementations, one or more of the indicator 564 or the display 566 may be omitted or combined.

As shown in FIG. 5, the user interface components 560 include a speaker 568. The speaker 568 may be similar to the speaker 138 shown in FIG. 1B, the audio components 218, 220, 222 shown in FIGS. 2A-2B, or the audio components 418, 420, 422 shown in FIGS. 4A-4B. Although one speaker 568 is shown in FIG. 5, the user interface components 560 may include multiple speakers. In some implementations, the speaker 568 may be omitted or combined with another component of the image capture apparatus 500, such as the microphone 514.

As shown in FIG. 5, the user interface components 560 include a physical input interface 570. The physical input interface 570 may be similar to the mode buttons 110, 210, 410 shown in FIGS. 1A, 2A, and 4A or the shutter buttons 112, 212, 412 shown in FIGS. 1A, 2B, and 4A. Although one physical input interface 570 is shown in FIG. 5, the user interface components 560 may include multiple physical input interfaces. In some implementations, the physical input interface 570 may be omitted or combined with another component of the image capture apparatus 500. The physical input interface 570 may be, for example, a button, a toggle, a switch, a dial, or a slider.

As shown in FIG. 5, the user interface components 560 include a broken line border box labeled “other” to indicate that components of the image capture apparatus 500 other than the components expressly shown as included in the user interface components 560 may be user interface components. For example, the microphone 514 may receive, or capture, and process audio signals to obtain input data, such as user input data corresponding to voice commands. In another example, the image sensor 512 may receive, or capture, and process image data to obtain input data, such as user input data corresponding to visible gesture commands. In another example, one or more of the spatial sensors 540, such as a combination of the accelerometer 544 and the gyroscope 546, may receive, or capture, and process motion data to obtain input data, such as user input data corresponding to motion gesture commands.

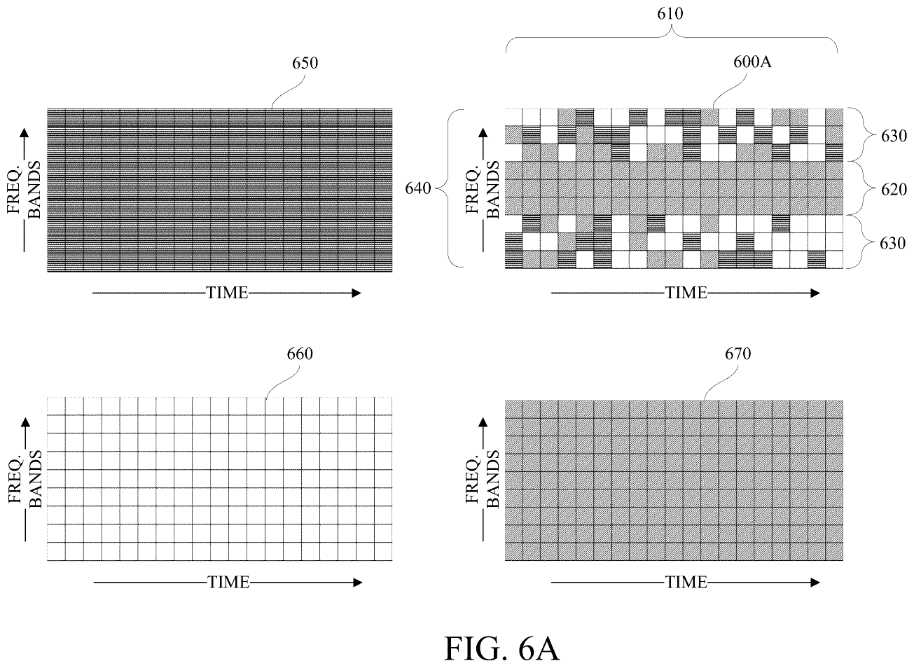

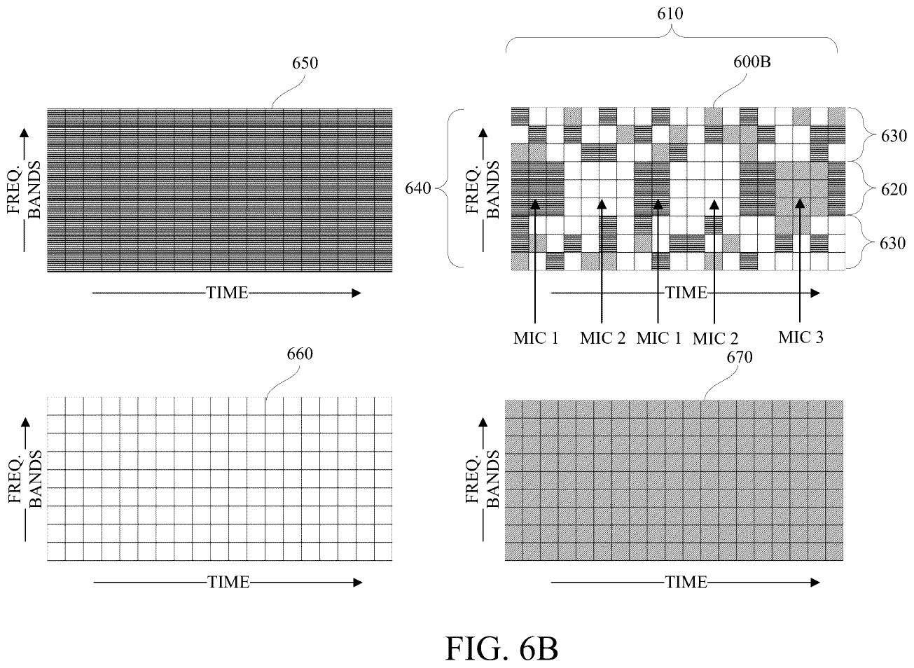

FIG. 6A is a block diagram of an example of a composite microphone signal 600A that is optimized for voice audio. The composite microphone signal 600A comprises frequency bands 610 shown as vertical columns. Each frequency band comprises a voice sub-band 620 and non-voice sub-bands 630. The voice sub-band 620 may have a frequency range from approximately 300 Hz to approximately 8000 Hz. Each frequency band 610 comprises frequency bins 640 shown as squares of the vertical columns. The frequency bins 640 may be selected from frequency bins of a first microphone signal 650 (shown in horizontal hatching), frequency bins of a second microphone signal 660, and frequency bins of a third microphone signal 670 (shown in diagonal hatching). In this example, the voice sub-band 620 is shown to have frequency bins selected from the third microphone signal 670. In other examples, the voice sub-band may have frequency bins selected from the first microphone signal 650, the second microphone signal 660, or any combination of the first microphone signal 650, the second microphone signal 660, and the third microphone signal 670. Three microphone signals are shown for simplicity and clarity, and it is understood that the composite signal may comprise frequency bins from any number of microphone signals.

FIG. 6B is a block diagram of another example of a composite microphone signal 600B that is optimized for voice audio. In this example, the selected frequency bins in the voice sub-band 620 may transition between any of the first microphone signal 650, the second microphone signal 660, and the third microphone signal 670. In this example, the energy of all the frequency bins comprising the voice sub-band 620 is computed and respectively averaged for each microphone signal. The frequency bins of the microphone signal that have the lowest energy of all the microphones are selected for each frequency bin in a respective frequency band. As shown in FIG. 6B, the frequency bin selection in the voice sub-band 620 transitions from the first microphone 650 to the second microphone 660, back to the first microphone 650, back to the second microphone 660, back to the first microphone 650, then to the third microphone 670, and then finally back to the first microphone 650. The microphone transition sequence shown in FIG. 6B is shown as an example, and the microphone transition sequence will change based on the specific conditions (e.g., environment) of the device. A minimum duration may be set to transition from one microphone to another microphone. The minimum duration may be based on the processing block size and is related to the Fast Fourier Transform (FFT) which determines the frequency bin size (e.g., 93.75 Hz). In an example, the minimum duration may be set to 5 ms such that the voice sub-band frequency bins are selected from a particular microphone for a minimum of 5 ms before switching to selecting voice sub-band frequency bins of another microphone. In some examples, smoothing may be applied (e.g., via a smoothing algorithm) when switching from selecting voice sub-band frequency bins from one microphone to another microphone. In an example, a first order low pass filter may be used to introduce some long term averaging on the energy measurement before the minimum value is selected.

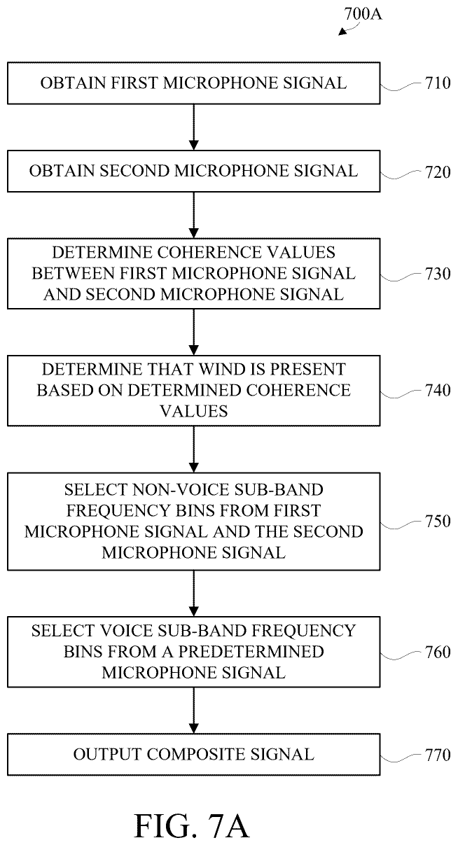

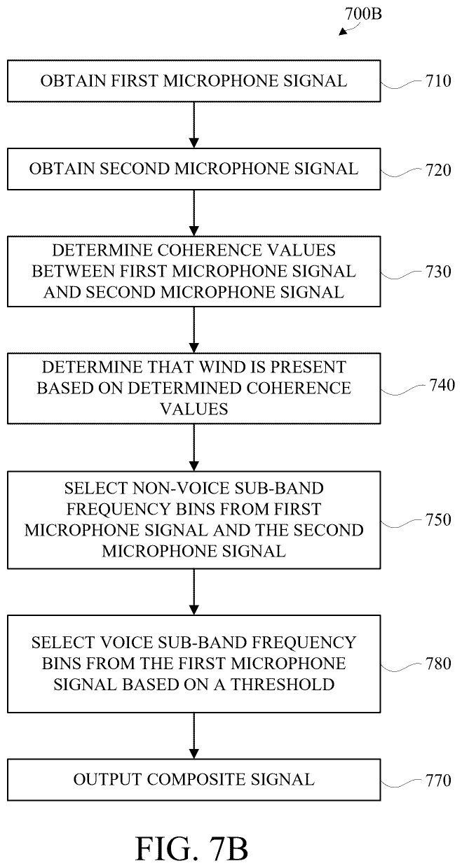

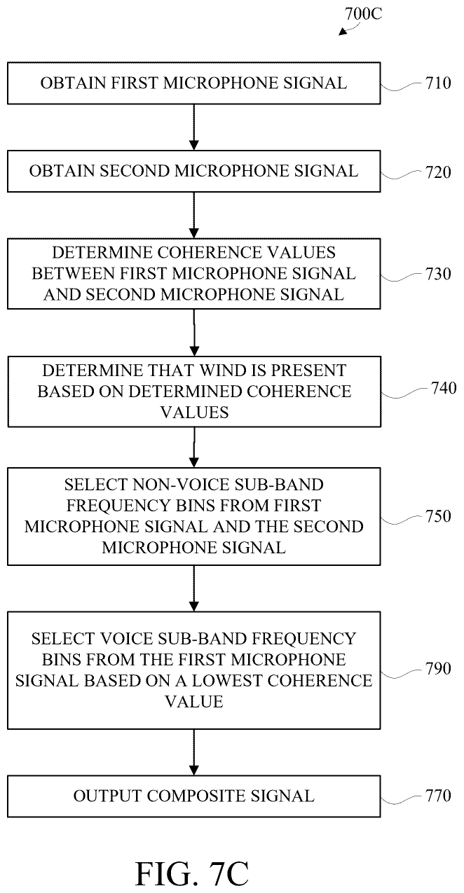

FIG. 7 is a flow diagram of an example of a method 700A for generating a composite microphone signal that is optimized for voice using a predetermined microphone signal for the voice sub-band. At 710, the method 700A includes obtaining a first microphone signal. The first microphone signal comprises frequency bins across a frequency band. The frequency band of the first microphone signal comprises a voice sub-band and non-voice sub-bands. The voice sub-band and the non-voice sub-bands of the first microphone signal each comprise frequency bins. Each frequency bin may have a predetermined size. The frequency bin size may be any division of the frequency domain. In an example where the FFT size is 256 at 24,000 Hz sampling rate, each frequency bin may be 93.75 Hz.

At 720, the method 700A includes obtaining a second microphone signal. The second microphone signal comprises frequency bins across a frequency band. The frequency band of the second microphone signal comprises a voice sub-band and non-voice sub-bands. The voice sub-band and the non-voice sub-bands of the second microphone signal each comprise frequency bins.

At 730, the method 700A includes determining coherence values between the first microphone signal and the second microphone signal. Determining coherence values between the first microphone signal and the second microphone signal includes determining a coherence value for each frequency bin of the respective microphone signals.

At 740, the method 700A includes determining that wind is present based on the determined coherence values. The coherence values of frequency bins 0-14 (e.g., below 1312.5 Hz) may be averaged to create a single value wind meter that varies from 0 to 1. Low wind meter values below a threshold (e.g., below 0.75) may indicate that wind is present, whereas high wind meter values (e.g., above 0.9) may indicate that wind is not present.

At 750, the method 700A includes selecting non-voice sub-band frequency bins from the first microphone signal and the second microphone signal. For example, the non-voice sub-band frequency bins with the lowest energy values may be selected. The lowest energy value may correspond to a high coherence value. In this example, if the energy value of the non-voice sub-band frequency bin for a particular block in a first microphone signal is lower than the energy value of that block in a second microphone signal, the non-voice sub-band frequency bin from the first microphone signal will be selected for that block.

At 760, the method 700A includes selecting voice sub-band frequency bins from a predetermined microphone signal. In an example, the predetermined microphone may be the first microphone. In another example, the predetermined microphone may be the second microphone.

At 770, the method 700A includes outputting a composite signal. The composite signal includes the selected non-voice sub-band frequency bins and the selected voice sub-band frequency bins.

FIG. 7B is a flow diagram of an example of a method 700B for generating a composite microphone signal that is optimized for voice using a threshold for selection of the voice sub-band frequency bins. Similar to FIG. 7A, the method 700B shown in FIG. 7B includes obtaining a first microphone signal at 710 and obtaining a second microphone signal at 720. The method 700B includes determining, at 730, coherence values between the first microphone signal and the second microphone signal and determining, at 740, that wind is present based on the determined coherence values.

At 750, the method 700B selects the non-voice sub-band frequency bins from the first microphone signal and the second microphone signal in the same manner as shown in FIG. 7A. At 780, the method 700B includes selecting voice sub-band frequency bins from the first microphone signal based on the average energy per microphone in the voice sub-band. At some point in time, a transition may be performed to select voice sub-band frequency bins from the second microphone signal based on the average energy per microphone in the voice sub-band. When transitioning from selecting voice sub-band frequency bins of the first microphone signal to selecting voice sub-band frequency bins of the second microphone signal, a smoothing algorithm may be applied to the voice sub-band. At 770, the method 700B includes outputting a composite signal. The composite signal includes the selected non-voice sub-band frequency bins and the selected voice sub-band frequency bins.

FIG. 7C is a flow diagram of an example of a method 700C for generating a composite microphone signal that is optimized for voice using a lowest coherence value for selection of the voice sub-band frequency bins. Similar to FIGS. 7A and 7B, the method 700C shown in FIG. 7C includes obtaining a first microphone signal at 710 and obtaining a second microphone signal at 720. The method 700C includes determining, at 730, coherence values between the first microphone signal and the second microphone signal and determining, at 740, that wind is present based on the determined coherence values.

At 750, the method 700C selects the non-voice sub-band frequency bins from the first microphone signal and the second microphone signal in the same manner as shown in FIGS. 7A and 7B. At 790, the method 700C includes selecting voice sub-band frequency bins from the first microphone signal based on a lowest coherence value. At some point in time, a transition may be performed to select voice sub-band frequency bins from the second microphone signal based on the lowest coherence value. When transitioning from selecting voice sub-band frequency bins of the first microphone signal to selecting voice sub-band frequency bins of the second microphone signal, a smoothing algorithm may be applied to the voice sub-band. At 770, the method 700C includes outputting a composite signal. The composite signal includes the selected non-voice sub-band frequency bins and the selected voice sub-band frequency bins.

The methods and techniques of wind avoidance optimization for voice audio described herein, or aspects thereof, may be implemented by an image capture apparatus, or one or more components thereof, such as the image capture apparatus 100 shown in FIGS. 1A-1B, the image capture apparatus 200 shown in FIGS. 2A-2B, the image capture apparatus 300 shown in FIG. 3, the image capture apparatus 400 shown in FIGS. 4A-4B, or the image capture apparatus 500 shown in FIG. 5. The methods and techniques of wind avoidance optimization for voice audio described herein, or aspects thereof, may be implemented by an image capture device, such as the image capture device 104 shown in FIGS. 1A-1B, one or more of the image capture devices 204, 206 shown in FIGS. 2A-2B, one or more of the image capture devices 304, 306 shown in FIG. 3, the image capture device 404 shown in FIGS. 4A-4B, or an image capture device of the image capture apparatus 500 shown in FIG. 5.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An image capture device, comprising:
a first microphone;
a second microphone; and
a processor configured to:
obtain a first microphone signal from the first microphone;
obtain a second microphone signal from the second microphone;
determine coherence values between the first microphone signal and the second microphone signal across a frequency band, wherein the frequency band comprises a voice sub-band and non-voice sub-bands, and wherein the voice sub-band and the non-voice sub-bands each comprise frequency bins and a coherence value is determined for each frequency bin;
determine that wind is present based on the determined coherence values for each frequency bin;
select non-voice sub-band frequency bins from the first microphone signal and the second microphone signal based on a lowest energy value of each respective non-voice sub-band frequency bin;
select voice sub-band frequency bins from a predetermined microphone signal; and
output a composite signal that comprises the selected non-voice sub-band frequency bins and the selected voice sub-band frequency bins.

2. The image capture device of claim 1, wherein the voice sub-band ranges from 300 Hz to 8000 Hz.

3. The image capture device of claim 1, wherein the predetermined microphone signal is the first microphone signal.

4. The image capture device of claim 1, wherein the predetermined microphone signal is the second microphone signal.

5. The image capture device of claim 1, wherein coherence values of a subset of the frequency bins are averaged to create a wind meter value that indicates a presence of wind.

6. The image capture device of claim 1, wherein the lowest energy value corresponds to a high coherence value.

7. The image capture device of claim 1, wherein each frequency bin is 93.75 Hz.

8. An image capture device, comprising:
a first microphone;
a second microphone; and
a processor configured to:
obtain a first microphone signal from the first microphone;
obtain a second microphone signal from the second microphone;
determine coherence values between the first microphone signal and the second microphone signal across a frequency band, wherein the frequency band comprises a voice sub-band and non-voice sub-bands, and wherein the voice sub-band and the non-voice sub-bands each comprise frequency bins and a coherence value is determined for each frequency bin;
determine that wind is present based on the determined coherence values for each frequency bin;
select non-voice sub-band frequency bins from the first microphone signal and the second microphone signal based on a lowest energy value of each respective non-voice sub-band frequency bin;
select voice sub-band frequency bins from the first microphone signal based on an average energy per microphone in the voice sub-band; and
output a composite signal that comprises the selected non-voice sub-band frequency bins and the selected voice sub-band frequency bins.

9. The image capture device of claim 8, wherein the processor is further configured to:
select voice sub-band frequency bins from the second microphone signal based on the average energy per microphone in the voice sub-band; and
apply a smoothing algorithm to the voice sub-band.

10. The image capture device of claim 8, wherein the voice sub-band frequency bins of the first microphone signal are selected for a minimum duration.

11. The image capture device of claim 10, wherein the minimum duration is 5 milliseconds.

12. The image capture device of claim 8, wherein the non-voice sub-band range is below 300 Hz.

13. The image capture device of claim 8, wherein coherence values of a subset of the frequency bins are averaged to create a wind meter value that indicates an absence of wind.

14. The image capture device of claim 8, wherein the lowest energy value corresponds to a high coherence value.

15. The image capture device of claim 8, wherein each frequency bin is 93.75 Hz.

16. A method, comprising:
obtaining a first microphone signal from a first microphone;
obtaining a second microphone signal from a second microphone;
determining coherence values between the first microphone signal and the second microphone signal across a frequency band, wherein the frequency band comprises a voice sub-band and non-voice sub-bands, and wherein the voice sub-band and the non-voice sub-bands each comprise frequency bins and a coherence value is determined for each frequency bin;
determining that wind is present based on the determined coherence values for each frequency bin;
selecting non-voice sub-band frequency bins from the first microphone signal and the second microphone signal based on a lowest energy value of each respective non-voice sub-band frequency bin;
selecting voice sub-band frequency bins from the first microphone signal based on a lowest coherence value; and
outputting a composite signal that comprises the selected non-voice sub-band frequency bins and the selected voice sub-band frequency bins.

17. The method of claim 16, further comprising:
selecting voice sub-band frequency bins from the second microphone signal based on the lowest coherence value; and
applying a smoothing algorithm to the voice sub-band.

18. The method of claim 16, wherein the voice sub-band frequency bins of the first microphone signal are selected for a minimum duration.

19. The method of claim 18, wherein the minimum duration is 5 milliseconds.

20. The method of claim 16, wherein the non-voice sub-band range is above 8000 Hz.
